(19) United States
(12) Patent Application Publication
(10) Pub. No.: US 2023/0230105 A1
(43) Pub. Date: Jul. 20, 2023

(54) SOCIAL MEDIA MANAGEMENT TOOL

(71) Applicant: Kylie K. CAMMON, Frisco, TX (US)

(72) Inventor: Kylie K. CAMMON, Frisco, TX (US)

(21) Appl. No.: 18/097,551

(22) Filed: Jan. 17, 2023

Related U.S. Application Data
(60) Provisional application No. 63/299,586, filed on Jan. 14, 2022.

(51) Int. Cl. G06Q 30/0201; G06Q 50/00; G06F 3/0482

(52) U.S. Cl. CPC G06Q 30/0201; G06Q 50/01; G06F 3/0482

(57) ABSTRACT

An online tool aggregates streaming data against social media data to allow artists and their teams gain a better understanding of what types of content drive up stream counts. User-owned social media accounts and DSP accounts are connected, and user profile data from the owned social media accounts and the DSP accounts is ingested. The social media content performance data from the user profile data is compared with the streaming platform performance data from the user profile data, and successful social media content performance is identified based on the comparison.

### CROSS-REFERENCES TO RELATED APPLICATIONS

This application claims the benefit of U.S. Provisional Patent Application No. 63/299,586, filed Jan. 14, 2022, the entire content of which is herein incorporated by reference.

### STATEMENT REGARDING FEDERALLY SPONSORED RESEARCH OR DEVELOPMENT

(Not Applicable)

### BACKGROUND

The invention relates to a social media management tool and, more particularly, to a social media management tool that aggregates available data to assist artists in measuring the effectiveness of their content.

Today, the music industry is heavily influenced by social media activity, especially on discovery platforms like TikTok and Instagram. According to a recent MRC Data study, 75% of TikTok users in the U.S. say that they use TikTok to discover new artists-enough to cause labels, digital streaming platforms (DSPs), and managers to look intently to social platforms when making decisions around new artists to sign and records to financially/editorially support.

In a world where streams/plays/views quite literally equal money, it's never been more important for the industry to understand the nuts and bolts of what types of digital marketing efforts are actually moving the needle for artist growth from a streaming perspective.

Between social and streaming platforms, there is no shortage of data pointing to the buzz (or lack thereof) of artists and their music—the issue at hand is that there is currently no way to aggregate this data in order to assess the effectiveness of an artist's digital ecosystem (owned social, influencer, and other third party content) as a sum of its parts.

More simply put, today there is no workable way to determine what types of digital content/marketing efforts are driving increases in streaming results and what types digital content/marketing efforts are a waste of time and effort for artists and their teams.

### SUMMARY

Using technology made commonplace by Social Media Management Systems like Hootsuite, Sprinklr, Sprout, etc. and streaming metrics platforms like Chartmetric, the described embodiments define an online tool that aggregates streaming data against non-public social data (i.e., the data one can only access as the owner of a social account-post impressions, followers gained/lost, post clicks, post shares, etc.). The described platform allows artists and their teams to get a better understanding of what types of content—from paid partnerships to organic owned social posts to sponsored video—effectively drives up stream counts, and therefore dollar counts.

In an exemplary embodiment, a method of correlating a user's streaming platform performance data with the user's social media content performance data includes the steps of (a) retrieving user input relating to owned social media accounts and DSP accounts; (b) connecting the owned social media accounts and the DSP accounts; (c) ingesting user profile data from the owned social media accounts and the DSP accounts, the user profile data including user posts, third-party engagement data with the user posts, social media content performance data, and streaming platform performance data; (d) comparing the social media content performance data from the user profile data with the streaming platform performance data from the user profile data; and (e) identifying successful social media content performance data based on the comparison in step (d).

The method may include populating a dashboard with the user profile data and highlighting social media content performance data that exceeds a predetermined threshold. The predetermined threshold may be a percentage increase in third-party engagement compared to other social media content performance data. The predetermined threshold may be a percentage increase in third-party engagement compared to an average of the user's social media content performance data. The predetermined threshold may be defined by the user.

After step (b), the method may include enabling the user to select a look-back window, and ingesting the user profile data from the owned social media accounts and the DSP accounts from a time period defined by the look-back window.

The method may include enabling the user to append one or more in-platform tags to each of the user posts ingested in step (c). This step may be practiced by enabling the user to select multiple posts from a list view so that the user can append the in-platform tags to groups of posts all at once.

The method may include enabling the user to define conditional constructs for appending the in-platform tags such that the system may be programmed to automatically append the in-platform tags.

In some embodiments, the method may include populating a dashboard with subsets of the user profile data. The subsets of the user profile data may be selected by the user. The subsets of the user profile data may be selected by the system. The dashboard may be configurable to filter data by at least one of date range, sources, post type, and post tags.

In another exemplary embodiment, a computer system for correlating a user's streaming platform performance data with the user's social media content performance data includes a network interface enabling a user device running a computer program to request access to a social media analysis platform, and a system server running a server program that drives the social media analysis platform. The user device and the system server are interconnected by a computer network. The system server retrieves user input relating to user-owned social media accounts and DSP accounts, and the system server connects the user-owned social media accounts and the DSP accounts. The system server is programmed to ingest user profile data from the user-owned social media accounts and the DSP accounts, where the user profile data includes user posts, third-party engagement data with the user posts, social media content performance data, and streaming platform performance data. The system server compares the social media content performance data with the streaming platform performance data to arrive at a performance factor, and the system server identifies successful social media content performance data based on the performance factor.

In yet another exemplary embodiment, a method of correlating a user's streaming platform performance data with the user's social media content performance data includes the steps of (a) connecting the user's owned social media accounts and DSP accounts; (b) ingesting user profile data from the owned social media accounts and the DSP accounts, the user profile data including user posts, third-party engagement data with the user posts, social media content performance data, and streaming platform performance data; (c) comparing the social media content performance data from the user profile data with the streaming platform performance data from the user profile data; (d) identifying successful social media content performance data based on the comparison in step (c); and (e) populating a dashboard with the user profile data and highlighting social media content performance data that exceeds a predetermined threshold.

### BRIEF DESCRIPTION OF THE DRAWINGS

These and other aspects and advantages will be described in detail with reference to the accompanying drawings, in which:

FIG. 1 illustrates an exemplary computer system;

FIG. 2 shows the system connecting user-owned social media and DSP accounts;

FIG. 3 shows an example of post-tagging selection flow; and

FIG. 4 shows an exemplary dashboard.

### DETAILED DESCRIPTION

An online tool aggregates streaming data against social data to allow artists and their teams gain a better understanding of what types of content drive up stream counts. Once the system application or website is accessed, the user is provided with an option to create an account.

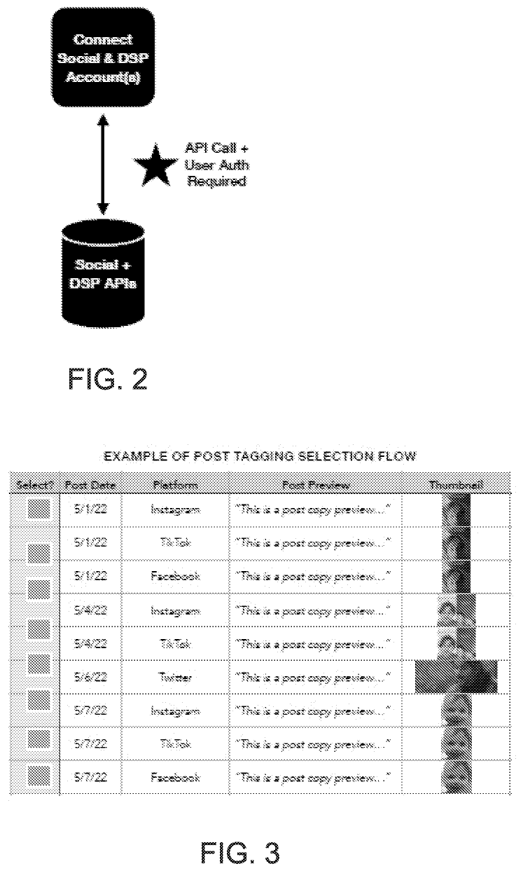

Free users simply gain access to a dashboard capable of showing public-facing social media data (e.g., profile follower count, average engagements per post, average engagement rate as a percentage of total engagements/total followers) for any public social media or DSP account across Facebook, Instagram, TikTok, YouTube, Twitter, Spotify, Apple Music, Amazon Music, Tidal, etc. Paid users retain the ability to see all of the items above plus the ability to connect their owned social media and DSP accounts—i.e., any social/DSP account(s) to which the user has lawful access via login credentials. See FIG. 2. This includes accounts across Facebook, Instagram, TikTok, YouTube, Twitter, Spotify, Apple Music, Amazon Music, Tidal, etc. This connection requires continuous data exchanges between social platform and DSP APIs.

Assuming the user has selected a paid option and has connected their social media and DSP accounts into the platform, the user selects their data look-back window. Users can choose to have the platform ingest the last 90 days of their owned profile data, thus making the platform instantly more useful. Otherwise, the platform begins to collect their data at the instant the account(s) are connected going forward. Most users can access at least the last 90 days of their data via each individual social platform's native analytics tools. That said, the value provided by the system of the described embodiments is in compiling all of that information in a single spot, plus allowing the users to overlay unique-to-them qualifiers (tags) in a way they cannot using native tools and data.

Once the user's owned social media posts begin to populate within the platform, the user is provided with the option to append in-platform tags to each post in order to categorize their posts by type. See FIG. 3. Users can select multiple posts at a time from a list view in order to append tags to groups of posts all at once. Users also have the opportunity to define conditional constructs (i.e., “if, then . . . ” rules) within the system settings that allow the platform to automatically tag owned content based on a series of user-provided conditional statements (e.g., “if post contains EXACTLY text “#tourlife” AND post published in 2023, THEN tag post, “Tour 2023”). Auto-tagging rules are stored within the system settings and can be edited/deleted at any time based on user needs. This feature is known and is currently being executed in the most advanced popular Social Media Management Systems (SMMS)-especially Sprinklr.

Once the data has populated from the social platforms/DSPs, the users will be presented with a drag-and-drop style customizable dashboard composed of “widgets” that can be customized based on user need. The user has an option to use an “out-of-the-box” dashboard populated with commonly-used data (e.g., total post impressions, total streams, total engagements, etc. . . . ) or to create custom dashboards built using widgets selected from a “bank” of available data. The user can also create their own custom metrics built using metrics provided by platforms within the system settings if needed (e.g., “[post engagements−video views=corrected engagements]).

The dashboard (custom and out-of-the-box) can be configured to filter data by the following:
Date Ranges (last 7 days, last 30 days, last 90 days, last 6 months, last year, or a custom date range)
Sources (Instagram, Facebook, TikTok, Twitter, Spotify, etc. . . . )
Post Type (Video, Photo, Text-Only, Multi-Photo, etc. . . . )
Post Tags (Examples: “Tour 2023,” “Behind the Scenes,” “New Release,” etc.)

From here, the user can review a single dashboard that showcases their social media content performance data alongside of their streaming platform performance data so that they can have a better understanding of which pieces of social content may have contributed to tangible streaming performance increases, thus allowing them to make better decisions on social content production going forward.

In some embodiments, the system is programmed to highlight social media content performance data that exceeds a predetermined threshold, e.g., by filling in the dashboard entry with color or the like. The predetermined threshold may be measured as a percentage increase in third-party engagement compared to other social media content performance data. Alternatively, the predetermined threshold may be a percentage increase in third-party engagement compared to an average of the user's social media content performance data. As yet another alternative, the predetermined threshold may be defined by the user. The performance factor is a nexus between the percentage increase and the streaming platform performance data.

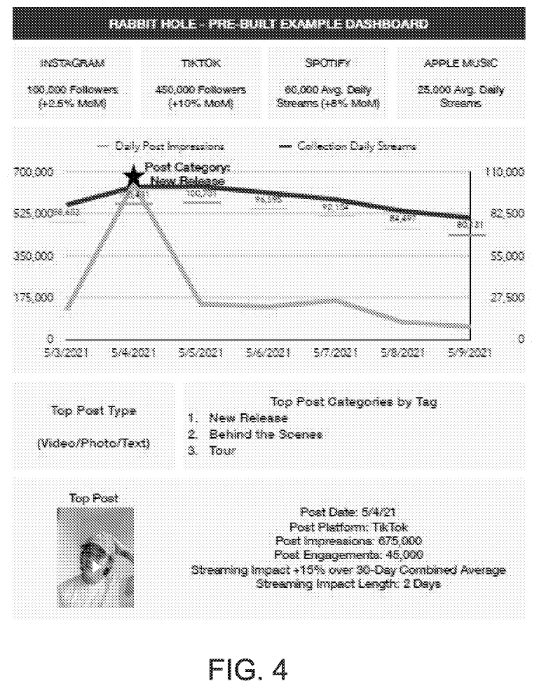

FIG. 4 shows an exemplary dashboard according to the described embodiments. The exemplary dashboard assumes the user has connected social media accounts Instagram and TikTok together with DSP accounts Spotify and Apple Music. In the example, the date has been filtered for 5/3/21-5/9/21. The dashboard in FIG. 4 shows a breakdown of key platform follower data, including Instagram, TikTok, Spotify, and Apple Music follower counts (including month over month percent change figures). In the highlighted graph, the date range appears on the X-axis, daily post impression count appears on the left axis and daily stream count appears on the right axis. This allows the user to identify a correlation between increases in stream counts with increases in post impression counts. In the example, the user can see that a sharp increase in post impression counts led to an increase in stream counts that gradually reduced over the course of several days

Users have the option to set up recurring reports to be shared by CSV or PDF to be delivered at a user-indicated interval to a specified list of emails. In a common exemplary use case, users receive a monthly social vs. streaming recap report to identify high-level trends in how posting frequency impacts overall post visibility, social engagement, and streaming in a single view. This feature (or similar) is known and is currently being executed in some popular Social Media Management Systems (SMMS) (e.g., Sprinklr, Sprout Social, Hootsuite, etc.). Users can also set up alerts to be sent to user-specified emails so that no one on their marketing/A&R team misses a hot moment. These alerts can be triggered by the following criteria:
Average Daily Stream Count x % over 30-Day Daily Average (combined DSP or single platform)
Social Post Passes X Views (e.g., 10,000, 100,000, 1 MM, etc.)
Social Post Driving High Engagement Levels (e.g. “+10% over last 30 day post engagement average)

The ordered combination of various ad hoc and automated tasks in the presently disclosed platform necessarily achieve technological improvements through the specific processes described above. In addition, the unconventional and unique aspects of these specific automation processes represent a sharp contrast to merely providing a well-known or routine environment for performing a manual or mental task.

The described invention may be embodied as one or more non-transitory computer readable media having instructions stored thereon for one or more aspects of the features as described and illustrated by way of the examples herein. The instructions in some examples include executable code that, when executed by one or more processors, cause the processors to carry out steps necessary to implement the methods of this technology.

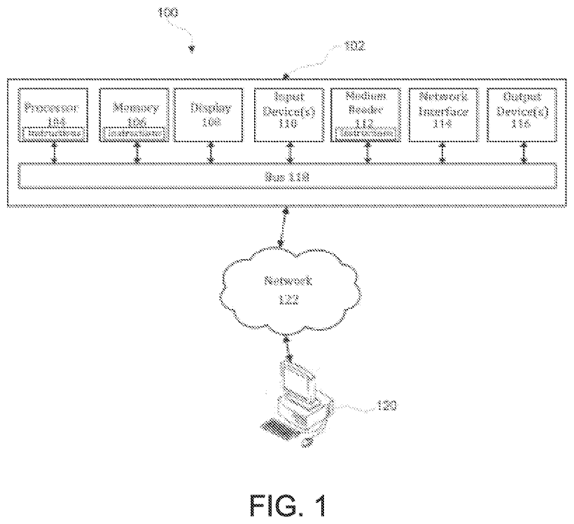

FIG. 1 shows an exemplary system for use in accordance with the embodiments described herein. The system 100 is shown schematically and may include a computer system 102, which is generally indicated. The computer system 102 may include a set of instructions that can be executed to cause the computer system 102 to perform any one or more of the methods or computer-based functions disclosed herein, either alone or in combination with other devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor, a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk. or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known.

The computer system 102 may also include at least one input device 110 such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the described embodiments, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of correlating a user's streaming platform performance data with the user's social media content performance data, the method comprising:
(a) retrieving user input relating to owned social media accounts and DSP accounts;
(b) connecting the owned social media accounts and the DSP accounts;
(c) ingesting user profile data from the owned social media accounts and the DSP accounts, the user profile data including user posts, third-party engagement data with the user posts, social media content performance data, and streaming platform performance data;
(d) comparing the social media content performance data from the user profile data with the streaming platform performance data from the user profile data; and
(e) identifying successful social media content performance data based on the comparison in step (d).

2. A method according to claim 1, further comprising populating a dashboard with the user profile data and highlighting social media content performance data that exceeds a predetermined threshold.

3. A method according to claim 2, wherein the predetermined threshold is a percentage increase in third-party engagement compared to other social media content performance data.

4. A method according to claim 2, wherein the predetermined threshold is a percentage increase in third-party engagement compared to an average of the user's social media content performance data.

5. A method according to claim 2, wherein the predetermined threshold is defined by the user.

6. A method according to claim 1, further comprising, after step (b), enabling the user to select a look-back window, and ingesting the user profile data from the owned social media accounts and the DSP accounts from a time period defined by the look-back window.

7. A method according to claim 1, further comprising enabling the user to append one or more in-platform tags to each of the user posts ingested in step (c).

8. A method according to claim 7, wherein the enabling step is practiced by enabling the user to select multiple posts from a list view so that the user can append the in-platform tags to groups of posts all at once.

9. A method according to claim 1, further comprising enabling the user to define conditional constructs for appending the in-platform tags, and automatically appending the in-platform tags.

10. A method according to claim 1, further comprising populating a dashboard with subsets of the user profile data.

11. A method according to claim 10, wherein the subsets of the user profile data are selected by the user.

12. A method according to claim 10, wherein the subsets of the user profile data are pre-selected.

13. A method according to claim 10, wherein the dashboard is configurable to filter data by at least one of date range, sources, post type, and post tags.

14. A computer system for correlating a user's streaming platform performance data with the user's social media content performance data, the computer system comprising:
a network interface enabling a user device running a computer program to request access to a social media analysis platform; and
a system server running a server program that drives the social media analysis platform, the user device and the system server being interconnected by a computer network, the system server retrieving user input relating to user-owned social media accounts and DSP accounts, and the system server connecting the user-owned social media accounts and the DSP accounts,
wherein the system server is programmed to ingest user profile data from the user-owned social media accounts and the DSP accounts, the user profile data including user posts, third-party engagement data with the user posts, social media content performance data, and streaming platform performance data,
the system server comparing the social media content performance data with the streaming platform performance data to arrive at a performance factor, and the system server identifying successful social media content performance data based on the performance factor.

15. A computer system according to claim 14, wherein the system server is programmed to populate a dashboard with the user profile data and highlight social media content performance data that exceeds a predetermined threshold.

16. A computer system according to claim 15, wherein the predetermined threshold is a percentage increase in third-party engagement compared to other social media content performance data, and wherein the performance factor comprises a nexus between the percentage increase and the streaming platform performance data.

17. A computer system according to claim 14, wherein the system server is programmed to enable the user via the network interface to append one or more in-platform tags to each of the ingested user posts.

18. A method of correlating a user's streaming platform performance data with the user's social media content performance data, the method comprising:
(a) connecting the user's owned social media accounts and DSP accounts;
(b) ingesting user profile data from the owned social media accounts and the DSP accounts, the user profile data including user posts, third-party engagement data with the user posts, social media content performance data, and streaming platform performance data;
(c) comparing the social media content performance data from the user profile data with the streaming platform performance data from the user profile data;
(d) identifying successful social media content performance data based on the comparison in step (c); and
(e) populating a dashboard with the user profile data and highlighting social media content performance data that exceeds a predetermined threshold.
